(19) United States
(12) Patent Application Publication
(10) Pub. No.: US 2008/0039540 A1
(43) Pub. Date: Feb. 14, 2008

(54) Process for recycling polyesters

(76) Inventor: Robert R. Reitz, West Chester, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/637,210

(22) Filed: Dec. 11, 2006

Related U.S. Application Data
(60) Provisional application No. 60/754,339, filed on Dec. 28, 2005.

(51) Int. Cl. C08J 11/24

(52) U.S. Cl. 521/48.5

(57) ABSTRACT

The present invention is directed towards a process for the recycling of polyesters comprising the steps of blending a starting polymer that is to be recycoled with an alkylene diol to form a blend, melting the blend and holding the melt blend under conditions of a first residence time, first temperature and shear to produce a cracked polymer. The cracked polymer blend can then be filtered, cooled and held under conditions such that solid phase polymerization takes place until a desired molecular weight is achieved.

### CROSS REFERENCE TO RELATED APPLICATIONS

This application claims the benefit of U.S. Provisional Application No. 60/754,339 filed Dec. 28, 2005.

### FIELD OF THE INVENTION

This invention relates to the recovery of polyesters post use, and in particular recovery by partial depolymerization of the polyester followed by filtering and repolymerization.

### BACKGROUND

Over the years there have been many technological developments in the field of production and use of polymers. Various additives, modifiers, comonomers, copolymers, and fillers have been incorporated into polymers to improve characteristics such as strength and temperature resistance, and to thereby meet the needs of more specialized applications. Polymers have also been used in conjunction with other materials to make complex systems and composites where separation of the individual materials would be difficult. In addition to material added in the manufactured polymer, post-consumer solid waste (i.e., that used by consumers and then discarded or placed into the solid waste) usually contains contamination introduced during consumer use of the article or during the collection process. The presence of these contaminants, and materials incorporated during manufacture, have limited the effectiveness of post-consumer plastic recycling. The problem is one of initial low purity of the desired plastic and the necessity to process a wide range of other materials that may be present.

Polyesters and polyamides, for example, may be recycled by various methods to yield useful polymers, oligomers and monomers. Traditional chemical recovery techniques include hydrolysis, glycolysis and methanolysis for polyesters, and hydrolysis and ammonolysis for polyamides. For polyesters, these methods are most often combined with an initial depolymerization step, which is accomplished by heating and/or dissolving the polymer in oligomers, monomers (such as ethylene glycol), or water.

Hydrolysis involves treating the starting polymer with water and heat. Complete depolymerization will yield monomers (e.g., terephthalic acid and ethylene glycol (EG) for polyethylene terephthalate (PET); and hexamethylene diamine and adipic acid for nylon 6,6), which can then be polymerized. For PET, additional additives such as salts, sodium or ammonium hydroxides or sulfuric acid, are sometimes used to enhance the process. See U.S. Pat. Nos. 4,355,175, 3,544,622, 3,952,053 and 4,542,239, respectively. Additionally, hydrolysis, specifically steam treatment, can by used in conjunction with other treatments discussed below, see U.S. Pat. No. 3,321,510.

Another recovery method for PET, glycolysis, is accomplished by using a glycol, e.g. ethylene glycol (EG) or 1,4-butanediol (BDO), to break down the polymer. This has been done in the liquid phase, and usually employs heat and pressure. Glycolysis of PET with ethylene glycol yields bis-β.-hydroxyethyl terephthalate (BHET) which is then usually filtered to remove impurities and polymerized, see U.S. Pat. No. 4,609,680. Glycolysis can be combined with a second step, e.g., methanolysis, see U.S. Pat. No. 3,321,510.

A method of recycling high molecular weight polyester, especially polyethylene terephthalate (“PET”), involves depolymerizing ground or crushed flakes of polyester via glycolysis. This process includes contacting the high molecular weight polyester with a glycol such as ethylene glycol to produce oligomers and/or monomers of the polyester. These materials are subsequently repolymerized as part of the preparation of new polyester articles. In the glycolysis of PET, the scrap PET is reacted with ethylene glycol, thus producing bis-(2-hydroxyethyl) terephthalate (“BHET”) and/or its oligomers. Glycolysis is an especially useful reaction for depolymerizing PET due to the fact that the BHET produced can be used as a raw material for both dimethyl terephthalate (“DMT”) based and terephthalic acid (“TPA”)-based PET production processes without major modification of the production facility. Glycolysis for depolymerizing polyester scrap recovered during various points in the manufacture of polyester articles is described in U.S. Pat. Nos. 3,884,850 and 4,609,680. U.S. Pat. No. 5,223,544 discloses a process whereby the foreign material present in post-consumer PET is removed by a process of first depolymerizing the polyester in a reactor via glycolysis to provide a mixture of PET oligomers, monomers, and various immiscible contaminants. The reaction mixture is then fed to an unstirred separation device whereby the contaminants are allowed to migrate away from the polyester on the basis of density, thereby forming an upper layer of low density contaminants, a middle layer of polyester material, and a lower layer of high density contaminants. The middle polyester layer is thereafter separated from the contaminants by being removed from the separation device through a draw-off pipe.

Also glycolysis is disclosed in U.S. Pat. No. 6,410,607 to Eastman. In the '607 patent a depolymerization and purification process comprises contacting a contaminated polyester with an amount of a glycol to provide a molar ratio of greater than about 1 to about 5 total glycol units to total dicarboxylic acid units at a temperature between about 150 to about 300° C. and an absolute pressure of about 0.5 to about 3 bars. The system is under agitation in a reactor for a time sufficient to produce in the reactor an upper layer comprising a relatively low density contaminant floating above a lower layer including a liquid comprising a depolymerized oligomer of said polyester.

The upper layer is separated from the lower layer by removing said upper layer from the reactor in a first stream and removing said lower layer from the reactor in a second stream.

In U.S. Pat. No. 6,417,239 also to Eastman, a method of making a condensation polymer/first polymer matrix is disclosed comprising the steps of preparing a polymer colloid system that in turn comprises
(i) a first polymer comprising latex polymer particles comprising a residue of an ethylenically unsaturated monomer;
(ii) a surfactant; and
(iii) a liquid continuous phase comprising a diol component, wherein the diol component comprises from about 25 to about 100% by weight of the continuous phase, and wherein the latex polymer particles are dispersed in the continuous phase.

The polymer colloid system is introduced into a glycolysis reaction medium prior to or during the glycolysis reaction wherein the glycolysis reaction medium comprises a polyester, copolyester, polyesteramide, polycarbonate or a mixture thereof. The glycolysis reaction medium optionally comprises a diol component.

The third method for breaking down polyesters, alcoholysis, e.g., methanolysis, breaks down the polymer back to its monomers. Conventional methanolysis generally operates using a polymer melt in which superheated methanol is bubbled through the mixture. See, for example, EPO Patent Application 0484963A3 and U.S. Pat. No. 5,051,528. Methanolysis can optionally include the use of catalysts to enhance the recovery rate, see, for example, U.S. Pat. Nos. 3,776,945 and 3,037,050, as well as the use of organic solvents, see U.S. Pat. No. 2,884,443. Methanolysis can be used in conjunction with various initial depolymerization methods, for example, dissolving the polymer in its oligomers, see U.S. Pat. No. 5,051,528; depolymerizing using EG, see Japanese Patent No. 58-020951 B4; or depolymerizing using water, see U.S. Pat. No. 3,321,510. After alcoholysis of PET with methanol and recovering the monomers, an additional refining step may be used to separate and purify the dimethyl terephthalate (DMT) from ethylene glycol (EG). This can be done by precipitation, distillation, or cystallization.

A route using methanolysis has been developed to recycle PET. Methanolysis that has the unique capability to separate the monomers from the contamination as vapors, allowing for further refining of DMT and ethylene glycol (2G). Treatment of the polymer with methanol yields DMT, methanol, and 2G. This process involves depolymerization of PET to dimethylteraphthalate (DMT) and ethylene glycol (2G). The methanol is first removed, followed by separation of the 2G from the DMT using distillation processes. Patents relevant to this process include EP 0 484 963, U.S. Pat. No. 5,532,404 and U.S. Pat. No. 5,710,315.

In other art for recycling polyesters, U.S. Pat. No. 5,395,858 describes a process for converting polyester into its original chemical reactants, said process comprising the steps of combining materials containing polyethylene terephthalate with an alkaline solution to form a slurry, then heating the slurry to a temperature sufficient to convert the polyethylene terephthalate contained within the slurry to disodium terephthalate and ethylene glycol, wherein said temperature is at the distillation temperature of ethylene glycol, and mixing the heated slurry with a quantity of water sufficient to dissolve said disodium terephthalate and form an aqueous solution of disodium terephthalic acid.

U.S. Pat. No. 5,580,905 discloses a process for recycling and converting polyester into usable chemical components, said process comprising the steps of combining materials containing polyester with an alkaline composition to form a mixture. The mixture is then heated to a temperature sufficient to convert the polyester contained within said materials to a corresponding acid salt of a polybasic organic acid and a polyol, the mixture being heated to at least the distillation temperature of said polyol for evaporating said polyol. The evaporated polyol thereby being separated from the acid salt.

The chemical structure of copolyetheresters (CPEE) is similar to polyesters in that they have ester linkages. An example is Hytrel®, available from Du Pont Company, Wilmington, Del., the structure of which is shown below.

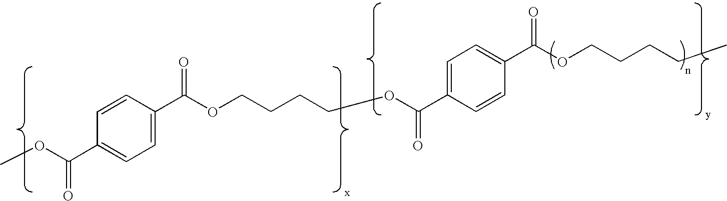

Methanolysis could be used to depolymerize CPEE into BDO (distilled), DMT (distilled), and polytetramethylene glycol (PTMEG) (remaining as a residue). One of the disadvantages with any of the abovementioned methods for recovering CPEE is that the component monomers need to be separated and purified, and then repolymerized in order to recover a usable polymer. PTMEG is not effectively recovered by these methods. CPEE's also additionally have antioxidants and other additives and it is unknown where they would end up in the process. A simple method for recovering CPEE's without the need to completely decompose the polymer into its component monomers is needed.

### SUMMARY

The present invention is directed towards a process for the recycling of polyesters comprising the steps of;
(i) providing a starting polymer,
(ii) blending the starting polymer with an alkylene diol, melting the starting polymer to form a melt blend, and holding the melt blend under conditions of a first residence time, first temperature and shear to produce a cracked polymer melt,
(iii) optionally filtering the cracked polymer melt,
(iv) cooling the cracked polymer melt until it is in a solid phase and optionally cutting it into pellets,
(iv) holding the solid phase under conditions of a second residence time and second temperature that solid phase polymerization takes place until a desired molecular weight is achieved.

The alkylene diol can be added to the starting polymer before, during, or after the melting step or any combination of these positions, and the cracked polymer melt has a melt flow index of between 5 and 50 times that of the starting polymer.

In one embodiment of the process the starting polymer comprises a polymer selected from the group consisting of polyethylene terephthalate, polypropylene terephthalate, polybutylene terephthalate, a copolyetherester, and blends and combinations thereof.

In a further embodiment of the process, the alkylene glycol is selected from the group consisting of 1,4-butanediol, 1,3-propanediol, and ethylene glycol.

In a still further embodiment of the process the starting polymer comprises filterable contaminants at a level of between 0. and 10% by weight of the total weight of polymer+contaminant, preferably 0 to 5% by weight, more preferably 0 to 2% by weight and most preferably 0 to 1% by weight.

In a still further embodiment of the process the melting and blending are carried out in a twin screw extruder, or a single screw extruder.

In a still further embodiment of the process the starting polymer is further blended with catalysts in step (ii) and where the catalyst is selected from the group consisting of salts of Li, Ca, Mg, Mn, Zn, Pb, Sb, Sn, Ge, and Ti.

In a still further embodiment of the process the salts are selected form the group consisting of acetate salts, oxides, glycol adducts, and alkoxides.

### DETAILED DESCRIPTION OF THE INVENTION

Typical polyesters for treatment by the present process include, but are not limited to, polyethylene terephthalate, polypropylene terephthalate (PPT), poly(1,4-butylene) terephthalate (PBT), and copolyesters, including copolyetheresters (CPEE) and liquid crystal polymers (LCPs). Mixtures of two or more of the aforementioned materials can be subjected to the improved depolymerization process of this invention.

The thermoplastic copolyetherester elastomers useful in this invention consist essentially of repeating long-chain ester units and short-chain ester units, as previously described hereinabove. The term “long-chain ester units” as applied to units in a polymer chain of the copolyetherester that is rendered flame retardant refers to the reaction product of a long-chain glycol with a dicarboxylic acid. Such “long-chain ester units”, which are a repeating unit in the copolyetheresters, correspond to formula (I) above. The long-chain glycols are polymeric glycols having terminal (or as nearly terminal as possible) hydroxy groups and a number average molecular weight from about 400-4000. The long-chain glycols used to prepare the copolyetheresters are poly(alkylene oxide)glycols having a carbon-to-oxygen atomic ratio of about 2.0-4.3. Representative long-chain glycols are poly(ethylene oxide) glycol, poly(1,2- and 1,3-propylene oxide)glycol, poly(tetramethylene oxide)glycol, random or block copolymers of ethylene oxide and 1,2-propylene oxide, and random or block copolymers of tetrahydrofuran with minor amounts of a second monomer such as ethylene oxide.

The term “short-chain ester units” as applied to units in a polymer chain of the copolyetherester that is rendered flame retardant refers to units made by reacting a low molecular weight diol having a molecular weight below about 250 with an aromatic dicarboxylic acid having a molecular weight below about 300, to form ester units represented by formula (II) above.

The term “low molecular weight diols” as used herein should be construed to include equivalent ester-forming derivatives, provided, however, that the molecular weight requirement pertains to the diol only and not to its derivatives.

Aliphatic or cycloaliphatic diols with 2-15 carbon atoms are preferred, such as ethylene, propylene, tetramethylene, pentamethylene, 2,2-dimethyltrimethylene, hexamethylene, and decamethylene glycols, dihydroxy cyclohexane and cyclohexane dimethanol.

The term “dicarboxylic acids” as used herein, includes equivalents of dicarboxylic acids having two functional carboxyl groups which perform substantially like dicarboxylic acids in reaction with glycols and diols in forming copolyetherester polymers. These equivalents include esters and ester-forming derivatives, such as acid anhydrides. The molecular weight requirement pertains to the acid and not to its equivalent ester or ester-forming derivative.

Among the aromatic dicarboxylic acids for preparing the copolyetherester polymers that are stabilized, those with 8-16 carbon atoms are preferred, particularly the phenylene dicarboxylic acids, i.e., phthalic, terephthalic and isophthalic acids and their dimethyl esters.

The short-chain ester units will constitute about 25-90 weight percent of the copolyetherester. The remainder of the copolyetherester will be long-chain ester units comprising about 10-75 weight percent of the copolyetherester. Preferred copolyetheresters contain 30-75 weight percent short-chain ester units and 25-70 weight percent long-chain ester units.

Preferred copolyetheresters for use in the compositions of this invention are those prepared from dimethyl terephthalate, 1,4-butanediol or ethylene glycol and poly(tetramethylene oxide)glycol having a number average molecular weight of about 600-2000 or ethylene oxide-capped poly(propylene oxide)glycol having a number average molecular weight of about 1500-2800 and an ethylene oxide content of 15-35% by weight. Optionally, up to about 30 mole percent of the dimethyl terephthalate in these polymers can be replaced by dimethyl phthalate or dimethyl isophthalate. The copolyetheresters prepared from 1,4-butanediol are especially preferred because of their rapid rates of crystallization.

The dicarboxylic acids or their derivatives and the polymeric glycol are incorporated into the copolyetherester in the same molar proportions as are present in the reaction mixture. The amount of low molecular weight diol actually incorporated corresponds to the difference between the moles of diacid and polymeric glycol present in the reaction mixture. When mixtures of low molecular weight diols are employed, the amounts of each diol incorporated is largely a function of the amounts of the diols present, their boiling points, and relative reactivities. The total amount of diol incorporated is still the difference between moles of diacid and polymeric glycol.

The copolyetheresters described herein are made by a conventional ester interchange reaction. A preferred procedure involves heating the dimethyl ester of terephthalic acid with a long-chain glycol and a molar excess of 1,4-butanediol in the presence of a catalyst at about 150° C.-260° C. and a pressure of 0.05 to 0.5 MPa, usually ambient pressure, while distilling off methanol formed by the ester interchange. Depending on temperature, catalyst, glycol excess and equipment, this reaction can be completed within a few minutes, e.g., about two minutes, to a few hours, e.g., about two hours. This procedure results in the preparation of a low molecular weight prepolymer which can be carried to a high molecular weight copolyetherester by distillation of the excess of short-chain diol. The second process stage is known as “polycondensation”.

Additional ester interchange occurs during this polycondensation which serves to increase the molecular weight and to randomize the arrangement of the copolyetherester units. Best results are usually obtained if this final distillation or polycondensation is run at less than about 670 Pa, preferably less than about 250 Pa, and about 200° C.280° C., preferably about 220° C.-2600° C., for less than about two hours, e.g., about 0.5 to 1.5 hours. It is customary to employ a catalyst while carrying out ester interchange reactions. While a wide variety of catalysts can be employed, organic titanates such as tetrabutyl titanate used alone or in combination with magnesium or calcium acetates are preferred. The catalyst should be present in the amount of about 0.005 to 2.0 percent by weight based on total reactants.

Both batch and continuous methods can be used for any stage of copolyetherester polymer preparation. Polycondensation of prepolymer can also be accomplished in the solid phase by heating divided solid prepolymer in a vacuum or in a stream of inert gas to remove liberated low molecular weight diol. This method has the advantage of reducing thermal degradation because it must be used at temperatures below the softening point of the prepolymer.

A detailed description of suitable copolyetherester elastomers that can be used in the invention and procedures for their preparation are described in U.S. Pat. Nos. 3,023,192, 3,651,014, 3,763,109, and 3,766,146, the disclosures of which are incorporated herein by reference. Typical copolyether esters are for example those made and marketed by Du Pont (Wilmington, Del.) under the name Hytrel®.

“Starting polymer” refers to any polymer that has been either aged in service or scrap or regrind from a processing operation and having a content of the desired polymer from about 100% to 90% by weight of polymer plus contaminants. Broadly, the starting polymer will comprise repeat units derived from:

(a) at least one dicarboxylic acid and/or carbonic acid and at least one diol; or

(b) at least one hydroxycarboxylic acid and/or aminocarboxylic acid; or

(c) at least one dicarboxylic acid and/or carbonic acid, at least one diol and/or diamine, and at least one hydroxycarboxylic acid and/or an aminocarboxylic acid.

By “filterable contaminants” is meant any material that is not the desired polymer and that can be caught by a melt filter as the melt flows past it. The contaminants may be non polymeric material such as metal, paper or polymer that is immiscible with the polyester. Filterable contaminants include additives, modifiers, comonomers, copolymers, and fillers incorporated during polymer preparation; as well as other material and polymers incorporated during article construction and contamination introduced during use or during collection. The process described herein is suitable for processing non-polymer contamination levels of about 0.0% to about 10%, by weight of the starting charge or feed.

By “starting polymer charge” is meant starting polymer loaded in a single batch, while “starting polymer feed” refers to starting polymer continuously fed to a reaction mass.

By “cracked polymer melt” is meant the product of the reaction in the melt of the starting polymer with alkylene glycol. “Cracking” refers to the process of molecular weight reduction that takes place to the cracked melt. The product of cracking is still a polymeric material, but of a lower molecular weight than the starting polymer. The lower molecular weight results in a an increase in melt flow rate of 5 to 50 times of the cracked polymer melt over that of the starting polymer under similar conditions of weight, temperature and orifice size.

By “reaction products”, herein is meant both a monomer capable of undergoing polymerization to make up the basic repeating unit of a polymer and any other product obtained from depolymerization of a polymer that can be chemically converted and subsequently polymerized. Examples of monomers that make up the basic repeating unit of a polymer are for polyesters, ethylene glycol and dimethyl terephthalate.

The term “alkylene glycol” is used herein to mean a compound having two or more hydroxyl groups which are attached directly to saturated (alkyl) carbon atoms. Other functional groups may also be present in the alkylene glycol, so long as they do not interfere with polymerization. Alkylene glycols having boiling points in the range of from 180° C. up to about 280° C. are most suitable for use according to the invention because of their ability to produce a substantial vapor pressure under solid state polymerization conditions. Suitable alkylene glycols include HO(CH₂)ₙ OH where n is 2 to 10; 1,4-bis(hydroxymethyl)cyclohexane; 1,4-bis(hydroxymethyl)benzene; bis(2-hydroxyethyl)ether; 3-methyl-1,5-pentanediol; and 1,2,4-butane-triol. Preferred alkylene glycols for their commercial applicability and ease of processing are ethylene glycol; 1,3-propylene glycol; and 1,4-butanediol.

### EMBODIMENTS OF THE INVENTION

The process of the invention comprises first the steps of providing a polyester and blending with it an alkylene diol. The polyester will may be a recycled grade containing impurities containing 0-10% by weight of impurities, and preferably 0-5% by weight of impurities, more preferably 0-2% by weight of impurities and most preferably 0-1% by weight of impurities. Blending can be accomplished by any means known to one skilled in the art, and examples of methods are spraying the diol onto the surface of polyester pellets, tumble blending the diol and polyester pellets, or injecting diol into a polymer melt, for example in an extruder.

The polyester melt plus diol blend is then melted, if it is not already melted, and subjected to shear and temperature sufficient to produce a reduction in molecular weight and hence a reduction in melt viscosity. The process of molecular weight reduction is referred to as “cracking”. Typical final melt flows of cracked resin are a factor of 5-50 times higher than the melt flow of the starting material. The cracking can take place in any device known to those skilled in the art for heating and/or shearing polymer melts. In a preferred embodiment, the cracking takes place in an extruder, and preferably a twin screw extruder. In a further embodiment of the invention, the extruder is fitted with a holding tube to provide additional residence time to the cracking process. The holding tube may optionally comprise a static mixer.

The melt is then filtered, cooled, and pelletized. Filtration of the cracked melt can be carried out by any means known to one skilled in the art. For example, there may be a filtration unit at the exit of the cracking extruder. The melt stream is then forced through a filter, preferably a screen pack filter of filters in series with the upstream filters being of a mesh for collecting only large particles and subsequent downstream filters being increasingly fine for collecting smaller particles that pass through the upstream filters, which removes unmelted solids prior to the melt stream reaching the pelletizer.

Alternatively, before reaching the pelletizer, the molten polymer is filtered through a series of sintered or fibrous metal gauzes or a bed of graded fine refractory material, such as sand or alumina, held in place by metal screens. Filtration removes large solid or gel particles that might otherwise interfere with the purity and final properties of the polymer after solid state polymerization.

Pelletization of the cracked and optionally filtered melt can be carried out by any equipment known to one skilled in the art for producing polymer pellets. The pellets are then subjected to solid state polymerization. “Solid state polymerization” (SSP) or solid phase polycondensation, is well known to those skilled in the art, and is described in greater detail in U.S. Pat. No. 3,801,547, the teachings of which are incorporated herein by reference. The low molecular weight pre-polymer particles, or granules, of the invention are subjected to a temperature of about 180° C. to about 280° C. while in an inert gas stream, e.g., nitrogen and/or a vacuum, for a period of time sufficient achieve the level of polymerization desired. What is significant and unexpected with respect to the present invention is that low molecular weight solid pre-polymer particles from contaminated recyclate which have the chemical composition described herein and a melt flow as much as 50 times higher than the starting, uncracked, polymer can be polymerized to high molecular weight polymers in the solid state. Furthermore, the physical properties obtained from polymerizing the pre-polymer particles of the invention match or exceed those obtainable by conventional melt condensation.

Optionally, added catalysts may be used within the process of the present invention. It has generally been found that the process of the present invention may be performed relying on the residual catalysts incorporated within the preformed polyester. However, it is contemplated that the use of additional catalysts will increase the rate of the process, if that is desired. Additional catalysts that may be used include salts of Li, Ca, Mg, Mn, Zn, Pb, Sb, Sn, Ge, and Ti, such as acetate salts and oxides, including glycol adducts, and Ti alkoxides. These are generally known in the art, and the specific catalyst or combination or sequence of catalysts used may be readily selected by a skilled practitioner. Catalyst can be added to the alkylene glycol before it is added to the starting polymer mass, or it can be added directly to the extruder.

Although most esterification catalysts can be used interchangeably, certain catalysts and catalyst concentrations are preferred for individual alkylene glycols. Using the preparation of poly(butylene terephthalate) from 1,4-butanediol as the alkylene glycol and terephthalic acid as the dicarboxylic acid as an example for the discussion which follows, preferred catalysts include hydrocarbyl stannoic acid or anhydride catalysts as described in greater detail in U.S. Pat. No. 4,014,858. Other catalysts, such as, for example, tetrabutyl titanate, may also be used with satisfactory results, but the risk of forming undesirable by-products during the reaction may be greater. When 1,3-propylene glycol is the alkylene glycol of choice, the risk of forming undesirable by-products using tetraalkyl titanates as catalyst is not as great. Thus, more traditional esterifications catalysts, e.g., tetrabutyl titanate and antimony oxide, can be used. When the alkylene glycol is ethylene glycol, metal oxide catalysts, such as antimony oxide and n-butyl stannoic acid, produce satisfactory results with minimum risk of undesirable side products being formed. Use of n-butyl stannoic acid and/or antimony oxide as esterification catalyst results in the esterification of terephthalic acid within an acceptable time period of three hours or less.

The amount of catalyst used in the process depends on the starting alkylene glycol and the selected catalyst. When metal alcoholate, acid and/or anhydride catalysts, such as, for example, tetrabutyl titanate or n-butyl stannoic acid, are used in the process, their amounts can typically range from about 0.02% to about 1.0% by weight of total catalyst, based on the total weight of dicarboxylic acid charged to the reactor. When metal oxides, such as antimony oxide, are used as catalysts, their amount can range from 10 ppm up to about 500 ppm.

Other catalyst systems are reported in U.S. Pat. Nos. 6,156,867; 6,034,202; 5,674,801; 5,652,033; 5,596,069; and 5,512,340;

### Example 1

In the following examples, melt flow index was measured according to ASTM 1238-79. For the “cracked” polyester samples the piston rod alone without the 2.1 kg weight was used. The piston rod had a weight of 110 grams and data are reported using a multiplying factor of 20 to the weight extruded.

CPEE (Hytrel® H-5556 from Du Pont) of melt flow index (MFI)=7.7 g/10 min was melted and blended with 0.25-1.0 wt. % of 1,4-butanediol BDO in a 30 mm twin screw extruder. BDO was injected via a liquid feed pump into the polymer melt and passed through a mixing zone for good distribution. Melt temperatures are held at 250-270° C. for a sufficient time to allow depolymerization to occur. Low M.W. product (“cracked product”) was isolated by quenching the melt strand in water with subsequent cutting to pellets. Melt flow index (MFI) was measured at 220° C. in units of grams/10 minutes.

Solid state polymerization (SSP) of the pellets was carried out on a 100 g batch by slowly removing monomer under heat and vacuum in a lab scale rotary evaporation unit with oil bath (185° C./<1 mm Hg vacuum) for 20-40 hr.

Samples were periodically taken for MFI analysis until goal molecular weight was reached.

Table 1 presents identifying parameters of process conditions and the physical properties from small compression molded samples.

TABLE 1

| | | Cracked | | % | |
|---|---|---|---|---|---|
| | | Product | | Elongation | % |
| BDO Feed | Melt | MFI | MFI at | at break | Elongation |
| rate wt-% on | Temp | (g/10 | 21 hr of | before | at break |
| Polymer | ° C. | min) | SSP | SSP | after SSP |
| Control | | 7.7 | | 1006 | |
| 0.00 | 255 | 10.2 | 2.6 | NM | 978 |
| 0.50 | 261 | 65 | 6.1 | 771 | 911 |
| 0.50 | 265 | 53 | 5.3 | 220 | 830 |
| 0.75 | 261 | 99 | 2.3 | 72 | 856 |

NM = not measured.

### Example 2

A second series of extruder cracking runs were made on a 30 mm twin screw extruder, using the same screw design as for example 1. To increase residence time for BDO cracking in the melt a tubular extension was added to the exit of the extruder and before the exit die for quenching. SSP was carried out as in example 1 only in 250 g batches. Tensile measurements were carried out according to ISO 527/2 type 1A at 50 mm/min. Table 2 shows data from this example.

TABLE 2

| | MFI | | Stress at | | |
|---|---|---|---|---|---|
| Wt-% | before | MFI after | Yield | Elongation | Elongation |
| BDO | SSP | SSP | MPa | at Yield % | at Break % |
| Control | 7.8 | 7.8 virgin | 14.3 | 34.3 | >450 |
| 0.0 | 16.4 | 16.4 no SSP | 14.3 | 32.0 | >450 |
| 0.5 | 220 | 9.3 | 14.4 | 35.3 | >450 |
| 1.0 | 1360 | 9.7 | 14.0 | 36.8 | >450 |

### Example 3

Copolyether ester was extruded on a 30 mm twin screw extruder, using the same screw design as for example 1 in the presence and absence of ground, crosslinked butyl rubber contaminant and the presence and absence of butane diol and a 200 mesh filter at the extruder exit. Pressure at exit of the screw was measured. Table 3 shows the pressures obtained and the reduction of pressure that can be obtained by the process of the invention even in the presence of contaminant.

TABLE 3

| BDO wt % | Contaminant wt % | Filter? | Pressure (psi) |
|---|---|---|---|
| 0.0 | 0.0 | no | 270 |
| 0.5 | 0.0 | no | 65 |
| 0.75 | 0.0 | no | 23 |
| 0.0 | 0.01 | no | 352 |
| 0.0 | 0.05 | no | 420 |
| 0.0 | 0.10 | no | 430 |
| 0.0 | 0.01 | yes | 500 |
| 0.0 | 0.05 | yes | 530 |
| 0.0 | 0.10 | yes | 480 |
| 0.5 | 0.01 | yes | 30 |
| 0.75 | 0.01 | yes | 20 |
| 0.5 | 0.05 | yes | 50 |
| 0.75 | 0.05 | yes | 20 |
| 0.5 | 0.10 | yes | 50 |
| 0.75 | 0.10 | yes | 50 |

The polyesters which are produced through the process of the present invention may incorporate additives, fillers, or other materials commonly taught within the art. Said additives may include thermal stabilizers, antioxidants, UV absorbers, UV stabilizers, processing aides, waxes, lubricants, color stabilizers, and the like. Said fillers may include calcium carbonate, glass, kaolin, talc, clay, carbon black, and the like. Said other materials may include nucleants, pigments, dyes, delusterants, such as titanium dioxide and zinc sulfide, antiblocks, such as silica, antistats, flame retardants, brighteners, silicon nitride, metal ion sequestrants, anti-staining agents, silicone oil, surfactants, soil repellants, modifiers, viscosity modifiers, zirconium acid, reinforcing fibers, and the like. These additives, fillers, and other materials may be incorporated within the polyesters of the present invention through a separate melt compounding process utilizing any known intensive mixing process, such as extrusion, through intimate mixing with the solid granular material, such as pellet blending, or through cofeeding within the process of the present invention. Alternatively, the additives, fillers, and other materials may be incorporated into the preformed polyester starting material prior to the process of the present invention. If said additives, fillers, and other materials are incorporated prior to or during the process of the present invention, it is important to ensure that they do not interfere with the process of the present invention.

The invention has been described above by reference to certain embodiments and examples which are not intended to be limiting to the scope of the claims listed herein. It will be understood that the scope of the claims also extends also to modifications of these embodiments by one skilled in the art.

We claim:

1. A process for the recycling of polyesters comprising the steps of;
(i) providing a starting polymer,
(ii) blending the starting polymer with an alkylene diol, melting the starting polymer to form a melt blend, and holding the melt blend under conditions of a first residence time, first temperature and shear to produce a cracked polymer melt,
(iii) optionally filtering the cracked polymer melt,
(iv) cooling the cracked polymer melt until it is in a solid phase and optionally cutting it into pellets,
(iv) holding the solid phase under conditions of a second residence time and second temperature that solid phase polymerization takes place until a desired molecular weight is achieved,
in which the alkylene diol is added to the starting polymer before, during, or after the melting step or any combination of these positions, and the cracked polymer melt has a melt flow index of between 5 and 50 times that of the starting polymer.

2. The process of claim 1 in which the starting polymer comprises a polymer selected from the group consisting of polyethylene terephthalate, polypropylene terephthalate, polybutylene terephthalate, a copolyetherester, and blends and combinations thereof.

3. The process of claim 1 in which the alkylene glycol is selected from the group consisting of 1,4-butanediol, 1,3-propanediol, and ethylene glycol.

4. The process of claim 1 in which the starting polymer comprises filterable contaminants at a level of between 0 and 10% by weight of the total weight.

5. The process of claim 1 in which the starting polymer comprises filterable contaminants at a level of between 0 and 5% by weight of the total weight

6. The process of claim 1 in which the starting polymer comprises filterable contaminants at a level of between 0 and 2% by weight of the total weight

7. The process of claim 1 in which the starting polymer comprises filterable contaminants at a level of between 0 and 1% by weight of the total weight

8. The process of claim 1 in which the melting and blending are carried out in a twin screw extruder, or a single screw extruder.

9. The process of claim 1 in which the starting polymer is further blended with catalysts in step (ii) and where the catalyst is selected from the group consisting of salts of Li, Ca, Mg, Mn, Zn, Pb, Sb, Sn, Ge, and Ti.

10. The process of claim 7 in which the salts are selected from the group consisting of acetate salts, oxides, glycol adducts, and alkoxides.
